(19) United States
(12) Patent Application Publication
(10) Pub. No.: US 2023/0109486 A1
(43) Pub. Date: Apr. 6, 2023

(54) A SYSTEM AND METHOD OF PRODUCTION OF MATT EFFECT OR MATT GLASS

(71) Applicant: YORGLASS CAM SANAYI VE TICARET ANONIM SIRKETI, Manisa (TR)

(72) Inventor: Hakan YORGANCILAR, Manisa (TR)

(21) Appl. No.: 17/044,344

(22) PCT Filed: Jun. 25, 2019
(86) PCT No.: PCT/TR2019/050501

§ 371 Date: Oct. 1, 2020

(51) Int. Cl. C03C 15/00; C03C 23/00; C03C 17/00; C03B 27/00

(52) U.S. Cl. CPC C03C 15/00; C03C 23/0075; C03C 17/007; C03B 27/00; C03C 2218/34; C03C 2218/328; C03C 2217/48; C03C 2203/20; C03C 2203/50; C03C 2204/08

(57) ABSTRACT

A system and method of production of matt effect or matt glass that eliminates the double-sided printing process in the production process of glasses used in products such as ovens, refrigerators, bottle cabinets, combi boilers, built-in appliances, fume hoods, stove glass, etc., prevents fingerprints on glass and increases the scratch resistance.

### TECHNICAL FIELD

The invention relates to a system and method of production of matt effect or matt glass to be used to mattify the glass used in the products of whitegoods sector.

The invention particularly relates to a system and method of production of matt effect or matt glass that eliminates the double-sided printing process in the production process of glasses used in products such as ovens, refrigerators, bottle cabinets, combi boilers, built-in appliances, fume hoods, stove glass, etc., prevents fingerprints on glass and increases the scratch resistance.

### PRIOR ART

Glass is an environmentally friendly, healthy, hygienic, aesthetic, and transparent material. These characteristics make the use of glass essential and indispensable in whitegoods manufacturing, where the main purpose is the healthy preparation and storage of foods.

In the related art, glass production process steps are cutting, grinding, drilling, screen printing and tempering. The screen printing process step in the mentioned production process is double-sided printing. Technically, the double-sided printing method cannot be used in the production of matte effect glass. Because, during the transport of the double-sided printed glasses on the conveyor, the rollers in mentioned conveyor damage the paint printed on the glass while turning and thus scrape off the matte effect. Therefore, the final product leaves the production as scraped and defected. Meanwhile, since these products are bright, they can easily be scratched and left fingerprints during use. This is not only undesirable for the user experience and but also adversely affects the appearance of the product.

The research in the literature application number TR2005/00789 as an example of production of matt glass can be shown. The application relates to equipment and method for mattifying the glass. In this application, the first receiving-depositing-carrying unit, which allows the glass to be held in the system by holding the suction cups; the 1st prewash-drying unit where stains and dust on the glasses are cleaned and drying process is performed; the mattifying unit where the etching process is carried out by applying the chemical substance to the lower surface of the glass; the 2nd final washing-drying unit where the matted glasses are washed and re-dried; and the second receiving-tilting-transporting unit from which the glass finish its process is mentioned. The mentioned mattifying unit includes lower rolls that allow the glass to be carried throughout the mattifying unit and top rolls that give directionality for printing. Therefore, abrasions and deformations occur on the surface of the glass which is conveyed by the mentioned rolls and simultaneously printed by a matte finish. This causes receiving defective products from the production line and the productivity loss in production.

As a result, the existence of the above problems and the inadequacy of existing solutions necessitated an improvement in the relevant technical field.

The Purpose of the Invention

The invention relates to a system and method of production of matt effect or matt glass to eliminate the disadvantages mentioned above and bring new advantages to the relevant technical field.

The main purpose of the invention is to produce matt effect or matt glass without double direction screen printing method.

Another purpose of the invention is to obtain matt effect or matt glass with a matte finish that does not hold fingerprints.

Another purpose of the invention is to obtain matt effect or matt glass that is resistant to scratch.

In order to fulfill all the purposes above and the ones that may arise from the detailed description, a system of production of matt effect or matt glass to be used to etching the glass used in the products of whitegoods sector, comprising a cutting unit in which the glass is cut, a grinding unit for the grinding of the glass, a drilling unit for the drilling of the glass, a printing unit for the printing of colors and patterns, and a tempering unit for tempering the glass, characterized by comprising;
an etching unit, comprising a first washing unit which provides cleaning and washing of the residues such as cutting oil, dirt and dust of the glasses cut in the cutting unit, an emulsion printing unit which enables the application of emulsion paint on glass surfaces to exclude the parts that do not want to be etched, a foiling unit that provides foil to be applied to the bottom side of the glass, an etching unit for etching glass, a second washing unit for cleaning the acidic mixture used in the etching unit from the glass surface, and a third washing unit for washing and cleaning the paint used in the emulsion printing unit.

The invention also relates to a method of production of matt effect or matt glass to be used to etching the glass used in the products of whitegoods sector. A feature of the invention is that it comprises;
a) washing or cleaning of the glass cut or supplied in cutting unit in first washing unit within the etching unit,
b) application of the emulsion printing in emulsion printing unit to determine the not-to-be-etched parts of the glasses washed in first washing unit,
c) etching the glasses with the acidic mixture in the etching unit,
d) chemical washing of the glasses in the second washing unit to ensure that the acidic mixture applied in the etching unit is removed from the surfaces of the glasses,
e) washing of the glass in the third washing unit to clean the paint residue used in the emission printing unit,
f) grinding of the glass, that is etched in the etching unit, in the grinding unit
g) tempering the glasses in the tempering unit

The structural and characteristic features and all advantages of the invention outlined in the drawings below and in the detailed description made by referring these figures will be understood clearly. Therefore, the evaluation should be made considering these figures and detailed explanations.

### BRIEF DESCRIPTION OF THE FIGURES

FIG. 1 is the schematic view of the system of the invention.

### REFERENCE NUMBERS

10. Cutting unit
20. Mattifying unit
21. First washing unit
22. Emulsion printing unit
23. Foiling unit
24. Etching unit
25. Second washing unit
26. Third washing unit
30. Grinding unit
40. Drilling unit
50. Printing unit
60. Tempering unit

### DETAILED DESCRIPTION OF THE INVENTION

In this detailed description, preferred structures of a system and method of production of matt effect or matt glass explained only for a better understanding of the subject matter and without any restrictive effect.

An invention relates to a system of production of matt effect or matt glass to be used to etching the glass used in the products of whitegoods sector, wherein; comprising
a cutting unit (10) for cutting glass in appropriate dimensions,
a mattifying unit (20), which ensures the etching of the cutted glass by means of various chemicals,
a grinding unit (30) for decreasing the sharpening of the edges of the etched glass,
a drilling unit (40) which allows the opening of the mounting holes on the glass,
a printing unit (50) which allows printing of colors or a pattern on the glass,
a tempering unit (60) which enables the glass to be strengthened and made resistant to cracking.

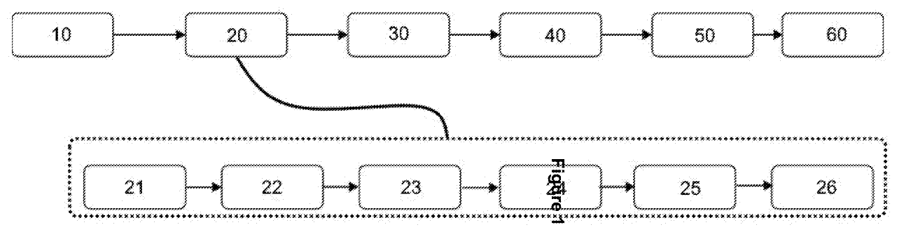

FIG. 1 gives a schematic view of the system. Accordingly, the cutting unit (10) is the section that allows the glass to be cut in appropriate dimensions. The glass cut in the mentioned cutting unit (10) is brought to the mattifying unit (20) to be matted with the help of various chemicals.

The mattifiying unit (20) in general comprises of a first washing unit (21) which provides cleaning and washing of the residues such as cutting oil, dirt and dust of the glasses cut in said cutting unit, an emulsion printing unit (22) which enables the application of emission paint on glass surfaces to exclude the parts that do not want to be etched, a foiling unit (23) that provides foil to be applied to the bottom side of the glass, an etching unit (24) for etching the glass, a second washing unit (25) for cleaning the acidic mixture used in the etching unit (24) from the glass surface, and a third washing unit (26) for washing and cleaning the paint used in the emulsion printing unit (22).

The grinding unit (30) is the part that ensures that the sharpness of the glass edges and corners is trimmed and made safe for the user. The glass etched in the mattifying unit (20) is brought to the grinding unit (30) and ground.

The drilling unit (40) is the section on which the mounting holes are opened to allow the glass to be installed on the products to be used. The holes are opened on the glass, that is ground in the grinding unit (30), in the drilling unit (40).

The printing unit (50) is the section that allows printing of color and patterns on the glass. The glasses drilled with holes in the drilling unit (40) are brought to the printing unit (50) and printed with the desired color and pattern.

The tempering unit (60) is the part that enables the glass to be strengthened and made resistant to cracking. Thus, the glass is broken into small and non-sharp pieces when hit, and the risk of injury is minimized. The glasses printed with the desired color and pattern in the printing unit (50) are made ready to use after being tempered in the tempering unit (60).

The invention also relates to a method of production of matt effect or matt glass to be used to mattifying the glass used in the products of whitegoods sector, wherein; comprising process steps of
a) washing or cleaning of the glass cut or supplied in the cutting unit (10) in the first washing unit (21) within the mattifying unit (20),
b) application of the emission printing in the emulsion printing unit (22) to determine the not-to-be-etched parts of the glasses washed in the first washing unit (21), c) etching the glasses with the acidic mixture in the etching unit (24),
d) chemical washing of the glasses in the second washing unit (25) to ensure that the acidic mixture applied in the etching unit (24) is removed from the surfaces of the glasses,
e) washing of the glass in the third washing unit (26) to clean the paint residue used in the emulsion printing unit (22),
f) grinding of the glass which is already etched in the mattifying unit (20) in the grinding unit (30),
g) tempering of the glass in the tempering unit (60).

Following the application of emulsion printing in the emulsion printing unit (22) in the aforementioned process step (b), application of foil to the bottom parts of the glass which is not desired to be etched is made in the foil unit (23), and then the glass leaving the foil unit (23) is etched with the help of the acidic mixture in the etching unit (24) as mentioned in the process step (d).

In the process step (f) mentioned above, following the grinding of the glass in the grinding unit (30), if the glass needs to have a hole according to the product to be used, the drilling operation is applied to the glass coming out of the grinding unit (30) in the drilling unit (40). Again, depending on the product where the glasses will be used, if the pattern and color printing are desired, the color and patterns are printed on the glass in the printing unit (50).

1. A system of production of matt effect or matt glass to be used to etching the glass used in the products of whitegoods sector, comprising a cutting unit in which the glass is cut, a grinding unit for the grinding of the glass, a drilling unit for the grinding of the glass, a printing unit for the printing of colors and patterns, and a tempering unit for tempering the glass, characterized by comprising:
a mattifying unit comprising a first washing unit which provides cleaning and washing of the residues such as cutting oil, dirt and dust of the glasses cut in the cutting unit an emulsion printing unit which enables the application of emulsion paint on glass surfaces to exclude the parts that do not want to be etched, a foiling unit that provides foil to be applied to the bottom side of the glass, an etching unit for etching glass, a second washing unit for cleaning the acidic mixture used in the etching unit from the glass surface, and a third washing unit for washing and cleaning the paint used in the emulsion printing unit.

2. A method of production of matt effect or matt glass to be used to etching the glass used in the products of whitegoods sector, characterized by comprising of the following steps:
a) washing or cleaning of the glass cut or supplied in cutting unit in first washing unit within the mattifying unit;
b) application of the emulsion printing in emulsion printing unit to determine the not-to-be-etched parts of the glasses washed in first washing unit;
c) etching the glasses with the acidic mixture in the etching unit;
d) chemical washing of the glasses in the second washing unit to ensure that the acidic mixture applied in the etching unit is removed from the surfaces of the glasses;
e) washing of the glass in the third washing unit to clean the paint residue used in the emulsion printing unit;
f) grinding of the glass which is already etched in the mattifying unit, in the grinding unit;
g) tempering of the glass in the tempering unit.

3. A method of production of matt effect or matt glass according to claim 2, characterized by comprising of the following steps: emulsion printing in the emulsion printing unit in the aforementioned process step (b), application of foil to the bottom parts of the glass which is not desired to be etched is made in foil unit.

4. A method of production of matt effect or matt glass according to claim 2, characterized by comprising of the following steps: in the process step (f) following the grinding of the glass in the grinding unit, application of drilling operation to the glass coming out of the grinding unit in the drilling unit.

5. A method of production of matt effect or matt glass according to claim 2, characterized by comprising of the following steps; following the grinding of the glass in the grinding unit or application of drilling to the glass in the drilling unit mentioned in the process step (f), printing of color and patterns on the glass in the printing unit.

6. A method of production of matt effect or matt glass according to claim 4, characterized by comprising of the following steps: following the grinding of the glass in the grinding unit or application of drilling to the glass in the drilling unit mentioned in the process step (f), printing of color and patterns on the glass in the printing unit.
